(19) United States
(12) Patent Application Publication
(10) Pub. No.: US 2019/0014210 A1
(43) Pub. Date: Jan. 10, 2019

(54) System and Method of Sending Information from a Caller to a Callee

(71) Applicant: Leigh M. Rothschild, Miami, FL (US)

(72) Inventor: Leigh M. Rothschild, Miami, FL (US)

(21) Appl. No.: 16/030,935

(22) Filed: Jul. 10, 2018

Related U.S. Application Data
(60) Provisional application No. 62/530,318, filed on Jul. 10, 2017.

(51) Int. Cl. H04M 3/436; H04M 1/57; H04L 12/58

(52) U.S. Cl. CPC H04M 3/4365; H04L 51/36; H04M 1/575

(57) ABSTRACT

A system and a method for sending information from a caller to a callee are disclosed. The method comprises receiving a connection request from a caller while the callee fails to receive a call from the caller. Post establishing a connection based on the connection request, a voice message is received from the caller. The voice message is translated into a text message using a speech to text translation technique. The speech to text translation technique is selected based on a processing power available with the system. Successively, the voice message is sent on the callee's phone.

### PRIORITY

This patent application claims the benefit of U.S. Provisional Application No. 62/530,318, filed on Jul. 10, 2017.

### FIELD OF THE DISCLOSURE

The present disclosure is generally related to sending information by a caller to a callee, and more particularly related to sending audio information in a textual form.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

Today, mobile phones are the most used devices by users. The mobile phones provide multiple modes of communication between the users. A few such modes include audio calling, video calling, messaging, and online chatting. Each mode has its associated advantages and disadvantages.

Video calling allows multiple users to communicate using mobile data. The users may see each other on displays, usually screens of the mobile phones. Along with video data, audio information is also exchanged between the users, through the video calling. Several software tools such Skype™, Google Duo™, and Facebook® offer such video calling options. But, video calling uses a large amount of mobile data and is thus an expensive method of communication.

For audio calls, the mobile phones may be used to make the calls to other user devices. The calls may be placed through a telecommunication network for exchanging audio information in a real time. But, a called user may not always be ready to attend the calls. Further, it is also not possible for users having auditory problems to talk over phone calls.

An existing alternative to the phone calls is a messaging system. A user may send important information to another user in form of messages. The messages are also delivered in real time. The messages may be read and replied by a receiving user when he finds time. The limitation associated with the messaging system is that it takes a lot of time and effort to type long messages. Further, the time taken to prepare the messages may vary for each user based on their typing speeds.

Online chatting tools are best used for quick exchange of brief information. It becomes tedious to type long messages using the online chatting tools. Thus, online chatting also involves the disadvantages similar to the messaging system, In consideration of the lying problems related to sending information to a user, there remains a need to allow a user to read content present in audio information sent by a user.

### BRIEF DESCRIPTION OF THE DRAWINGS

The accompanying drawings illustrate various embodiments of systems, methods, and embodiments of various other aspects of the disclosure. Any person with ordinary skills in the art will appreciate that the illustrated element boundaries (e.g. boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another, and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 illustrates a network connection diagram of a system 100 for sending information from a caller to a callee, according to an embodiment.

FIG. 2 illustrates a flow sequence diagram illustrating steps performed while sending information from a caller to a callee, according to an embodiment.

FIG. 3 illustrates a flow sequence diagram illustrating steps performed while sending information from a caller to a callee, according to another embodiment.

FIG. 4 illustrates a flowchart 400 of a method of sending information from a caller to a callee, according to an embodiment.

### DETAILED DESCRIPTION

Some embodiments of this disclosure, illustrating all its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items or meant to be limited to only the listed item or items.

It must also be noted that as used herein and in the appended claims, the singular forms “a,” “an,” and “the” include plural references unless the context clearly dictates otherwise. Although any systems and methods similar or equivalent to those described herein can be used in the practice or testing of embodiments of the present disclosure, the preferred, systems and methods are now described.

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

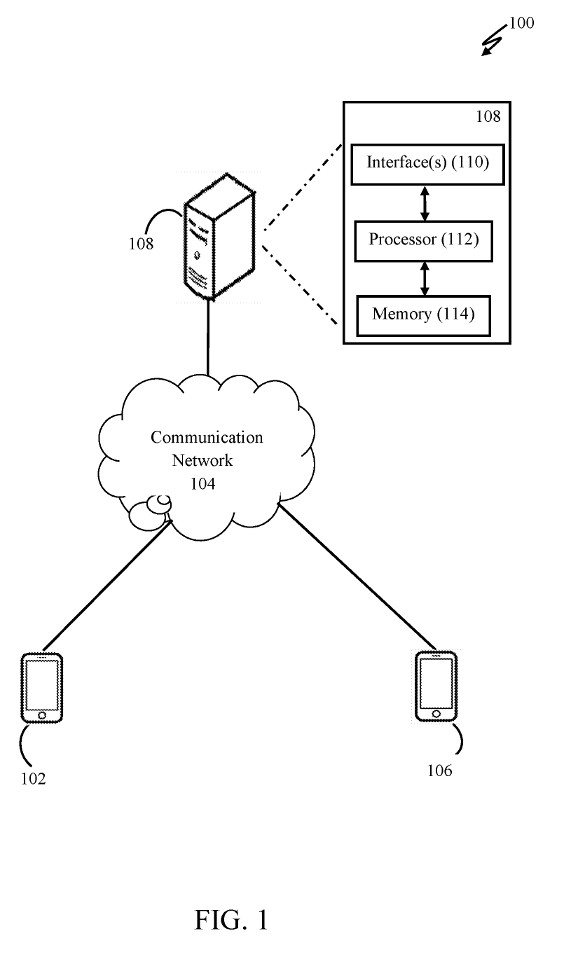

FIG. 1 illustrates a network connection diagram of the system 100 for sending information from a caller to a callee, according to an embodiment. FIG. 1 illustrates a caller's phone 102 connected to a communication network 104. Further, a callee's phone 106 is also shown to be connected to the communication network 104. A server 108 is also connected to the communication network 104. The server 108 comprises interface(s) 110, processor 112, and a memory 114.

The communication network 104 may be implemented using at least one communication technique selected from Visible Light Communication (VLC), Worldwide Interoperability for Microwave Access (WiMAX), Long term evolution (LTE), Wireless local area network (WLAN), Infrared (IR) communication, Public Switched Telephone Network (PSTN), Integrated Services Digital Network (ISDN), Broadband, cellular, Optical Fibre network, and Radio waves.

The interface(s) 110 may be used by a user to program the server 108. The interface(s) 110 may be used either to accept an input from the user or to provide an output to the user or performing both the actions. The interface(s) 110 may be at least one of a Command Line Interface (CLI) or a Graphical User Interface (GUI).

The processor 112 may execute an algorithm stored in the memory 114 for sending information from a caller to a callee. The processor 112 may also be configured to decode and execute any instructions received from one or more other electronic devices or server(s). The processor 112 may include one or more general purpose processors (e.g., INTEL microprocessors) and/or one or more special purpose processors (e.g., digital signal processors or Xilinx System On Chip (SOC) Field Programmable Gate Array (FPGA) processor). The processor 112 may be configured to execute one or more computer-readable program instructions, such as program instructions to carry out any of the functions described in this description.

The memory 114 may include, but is not limited to, fixed (hard) drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, or other type of media/machine-readable medium suitable for storing electronic instructions.

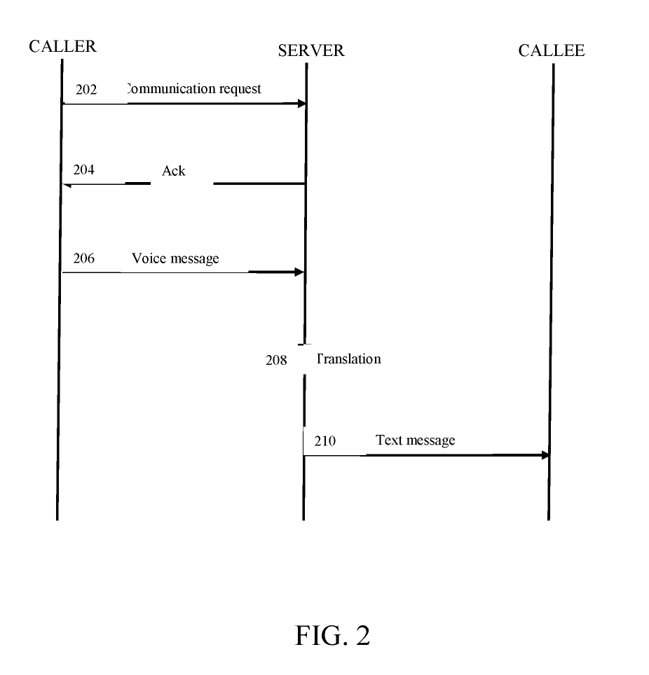

In one embodiment, a caller using the caller's phone 102 may need to send information on a callee's phone 106, as illustrated using flow sequence diagram of FIG. 2. At first, the caller's phone 102 may send a connection request to a server 108, at step 202. The connection request may be sent to the server 108 while the callee fails to receive a call from the caller. The connection request may be sent through the communication network 104.

In one embodiment, the connection request may be identified by a unique number indicating the server 108. For example, the caller may dial a number ‘98119’ for placing the connection request. The number ‘98119’ may be indicative of the server 108 present on a telecommunication network and thus may be reached. In another case, the connection request may be identified by a special key followed by a callee's phone number, in one case. The special key may either be an asterisk (*) key, pound (#) key, or any other key different from the number keys present on a phone.

In one embodiment, the connection request may be identified by a unique combination of numbers and at least one special character. For example, the connection request may be placed by entering ‘12*12#’. Further, different alphabets and other special characters may be used in different embodiments.

In one embodiment, press of a particular key for a predefined duration may place a connection request to the server 108. For example, in one case, the caller may press the ‘#’ key for five seconds to place the connection request to the server 108. In another case, the caller may press the ‘0’ key for three seconds to place the connection request to the server 108.

In one case, the caller may enter #-123-456-789 using a keypad of the caller's phone 102. The caller's phone may be a basic mobile phone with a keypad or a smart phone having a touch screen. The user pressing the pound (#) key may act as a connection request to the server 108. Based on the connection request, the server 108 may establish a connection with the caller's phone 102.

In one embodiment, the server 108 may optionally send an acknowledgement towards establishment of the connection, at step 204. The sever 108 may identify a total bandwidth available for communication and an amount of free bandwidth. In case, the free bandwidth is available, the server 108 may transmit the acknowledgement. Thus, the server 108 may avoid sending the acknowledgement during an absence of the free bandwidth, to avoid data packets from getting affected by network lag or jitter.

Post establishing the connection, the server 108 may receive a voice message from the caller's phone 102, at step 206. The caller may speak over and the voice message may be stored in the memory 114. In one case, a pre-recorded voice message stored in a memory of the caller's phone 102 may be used. In one case, the server may comprise a Voice Activity Detector (VAD) and a speech detector for identifying voice of a caller. An unknown caller may thus be barred from recording the voice message using the caller's phone.

Successively, the server 108 may translate the voice message into a text message, at step 208. The translation operation may be performed using a suitable speech to text translation technique. For example, existing voice to text conversion software tools such as Briana, FluentSoft, Speech Assistant, Speechlogger, Protokol, Crescendo Speech Processing, Rubidium, Verbatim, and Delta Touch may be used for performing the speech to text translation. In one case, processing power required by the voice to text translation tool may be determined and one may be selected for further use based on processing power available with the server 108. The server 108 may use different voice to text translation tool, at each time, based on availability of the processing power with the server 108.

In one embodiment, a suitable language of translation may also be selected during the translation operation. For example, the voice message may be recorded in Spanish language. The voice message may be translated into a text in English. In one case, the voice message may be simultaneously translated into multiple languages for sending the translated messages i.e. the text messages, to different callees.

In one embodiment, the text message may be present at the server 108 in an encrypted format. The encryption may be performed using encryption techniques such as Rivest Shamir Adleman (RSA), Triple Data Encryption Standard (DES), Blowfish, Twofish, Advanced Encryption Standard (AES) and the like. The encryption may be performed using a 32-bit or 64-bit encryption standard.

In one embodiment, the server 108 may send the text message on the callee's phone number, at step 210. Alternatively, the server may send the text message using an Internet Protocol (IP) address of the callee's phone 106. In case, the callee's phone number is for a landline phone, the server 108 may identify a mobile number of the callee, stored as an alternate phone number. Successively, the server 108 may send the text message on the mobile number of the callee. Further, an e-mail address of the callee may also be used for receiving the information, in one case. The server 108 may either send the text message or the voice message in a digital audio form, to the e-mail address of the callee.

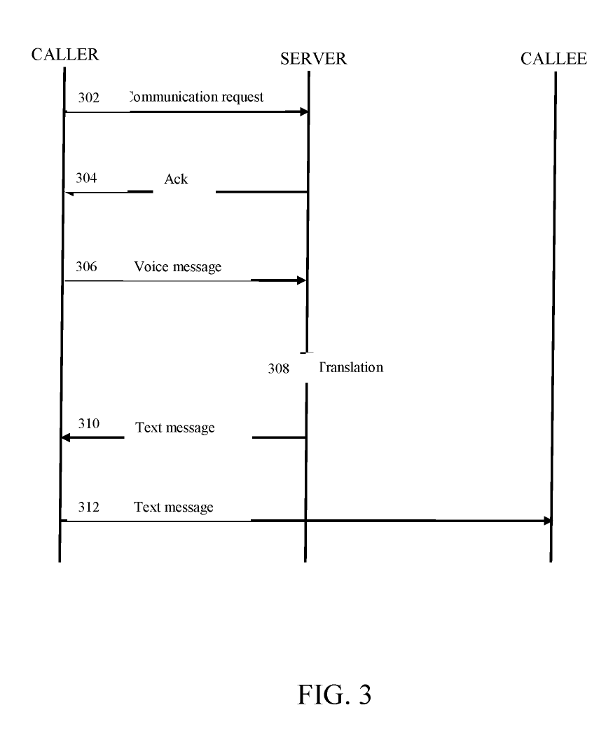

In another embodiment, a caller using the caller's phone 102 may need to send information on the callee's phone 106, as illustrated using flow sequence diagram of FIG. 3. At first, the caller's phone 102 may send a connection request to a server 108, at step 302. The connection request may be sent to the server 108 while the callee fails to receive a call from the caller. The connection request may be sent through the communication network 104. The connection request may be identified by the special key. The special key may either be an asterisk key (*) or a pound key (#), or any other key different from the number keys present on a phone.

In one case, the caller may press the asterisk (*) key using a keypad of the caller's phone 102. Pressing the asterisk (*) key may act as a connection request to the server 108. Based on the connection request, the server 108 may establish a connection with the caller's phone 102. The server 108 may optionally send an acknowledgement towards establishment of the connection, at step 304.

Post establishing the connection, the server 108 may receive a voice message from the caller's phone 102, at step 306. The caller may speak over and the voice message may be stored in the memory 114.

Successively, the server 108 may translate the voice message into a text message, at step 308. The translation operation may be performed using a suitable speech to text translation technique, selected from the ones mentioned above. Further, a suitable language of translation may also be selected during the translation operation.

After translating the voice message into the text message, the server 108 may send the text message on the caller's phone, at step 310. The caller may then send the text message to the callee's phone 106 using callee's phone number, at step 312. Alternatively, the text message may be sent using an Internet Protocol (IP) address of the callee's phone 106. Further, the e-mail address of the callee may also be used for receiving the information, as mentioned above. The server 108 may either send the text message or the voice message in a digital audio form, to the e-mail address of the callee.

It is well understood that the above explained embodiments of present disclosure may be implemented with modifications lying within scope of the present disclosure. A few of such modifications may comprise using different speech to text translation techniques. It is also understood that the above disclosure is used for sending information by a caller to a callee for different purposes.

The above disclosure leverages different techniques for enabling the disclosed method and system. Further, the system 100 offers several advantages over the communication techniques known in the art. When compared to the video calling technique, the system 100 utilizes less bandwidth for enabling the communication between the caller and the callee. Further, the disclosed method of communication could be implemented even during availability of a weak mobile network.

The system 100 and method may also be configured to utilize data compression techniques and standards. The data compression techniques supported by the system 100 may include, but not limited to, Adaptive Multi-Rate Wideband (AMR-WB), Half-rate, Full-rate, G.722, G.723, G.726, G.728, and G.729. The caller may have the option to select a compression technique, to be used, for compressing the voice message sent to the server 108.

Further, advantages of the present system 100 and method over the audio calls are already evident from the above disclosure, as the caller may be able to communicate with the callee while the callee is unavailable to pick the call.

Present system 100 and method are also advantageous over the messaging system and the online chatting tools by saving a caller's time to type the text message.

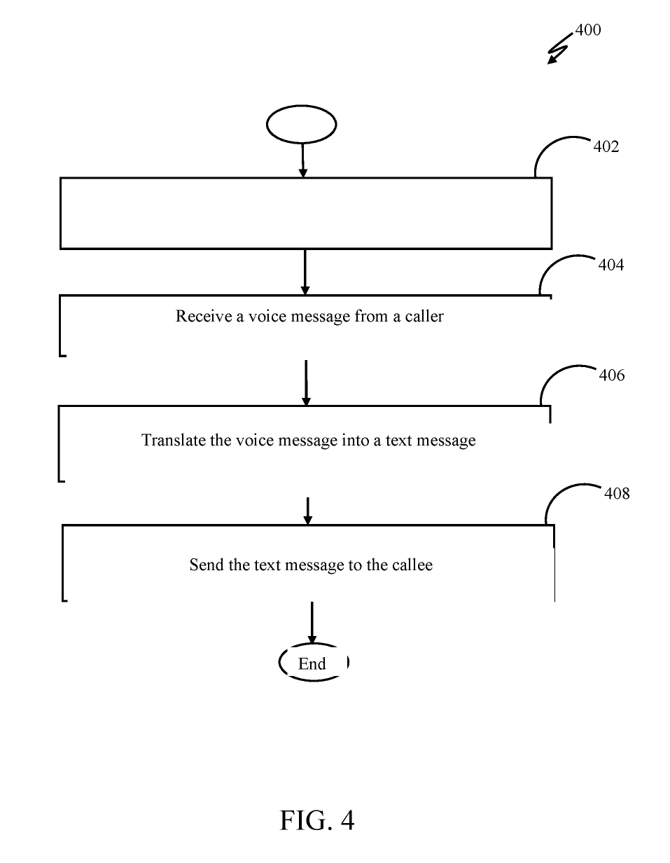

FIG. 4 illustrates a flowchart 400 of a method of sending information from a caller to a callee, according to an embodiment. FIG. 4 comprises a flowchart 400 that is explained in conjunction with the elements disclosed in FIG. 1.

The flowchart 400 of FIG. 4 shows the architecture, functionality, and operation for sending information from a caller to a callee. In this regard, each block may represent a module, segment, or portion of code, which comprises one or more executable instructions for implementing the specified logical function(s). It should also be noted that in some alternative implementations, the functions noted in the blocks may occur out of the order noted in the drawings. For example, two blocks shown in succession in FIG. 4 may in fact be executed substantially concurrently or the blocks may sometimes be executed in the reverse order, depending upon the functionality involved. Any process descriptions or blocks in flowcharts should be understood as representing modules, segments, or portions of code which include one or more executable instructions for implementing specific logical functions or steps in the process, and alternate implementations are included within the scope of the example embodiments in which functions may be executed out of order from that shown or discussed, including substantially concurrently or in reverse order, depending on the functionality involved. In addition, the process descriptions or blocks in flow charts should be understood as representing decisions made by a hardware structure such as a state machine. The flowchart 400 starts at the step 402 and proceeds to step 408.

At step 402, a connection request may be received from a caller. The connection request may be sent to the server while a callee fails to receive a call from the caller. The connection request may be identified by a special key which may or may not be followed by a callee's phone number. In one embodiment, the connection request may be received by a server 108.

At step 404, a voice message may be received from a caller. In one embodiment, the voice message may be received by the server 108.

At step 406, the voice message may be translated into a text message. The voice message may be translated using a speech to text translation technique. In one embodiment, the voice message may be translated by the server 108.

At step 408, the text message may be sent to the callee. In one embodiment, the voice message may be sent to the callee by the server 108. In another embodiment, the voice message may be sent to the caller's device 102 for forwarding to the callee's device 106.

Embodiments of the present disclosure may be provided as a computer program product, which may include a computer-readable medium tangibly embodying thereon instructions, which may be used to program a computer (or other electronic devices) to perform a process. The computer-readable medium may include, but is not limited to, fixed (hard) drives, magnetic tape, floppy diskettes, optical disks, compact disc read-only memories (CD-ROMs), and magneto-optical disks, semiconductor memories, such as ROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware). Moreover, embodiments of the present disclosure may also be downloaded as one or more computer program products, wherein the program may be transferred from a remote computer to a requesting computer by way of data signals embodied in a carrier wave or other propagation medium via a communication link (e.g., a modem or network connection).

What is claimed is:

1. A method of sending information from a caller to a callee, the method comprising:
receiving, by a server, a connection request from a caller, wherein the connection request is identified by a special key followed by a callee's phone number;
receiving, by the server, a voice message from the caller;
translating, by the server, the voice message into a text message; and
sending, by the server, the text message on the callee's phone number.

2. The method of claim 1, wherein the connection request is sent to the server while the callee fails to receive a call from the caller.

3. The method of claim 1, wherein the special key is one of an asterisk (*) key and a pound (#) key.

4. The method of claim 1, further comprising sending the text message on an Internet Protocol (IP) address of the callee's phone.

5. The method of claim 1, further comprising sending the text message on an e-mail address of the callee.

6. The method of claim 1, further comprising sending the voice message in a digital audio form, on an e-mail address of the callee.

7. A method of sending information from a caller to a callee, the method comprising:
receiving, by a server, a connection request from a caller, wherein the connection request is identified by a special key followed by the caller's phone identity;
receiving, by the server, a voice message from the caller;
translating, by the server, the voice message into a text message;
sending, by the server, the text message on the caller's phone; and
sending, by the caller's phone, the text message on a callee's phone.

8. The method of claim 7, wherein the connection request is sent to the server while the callee fails to receive a call from the caller.

9. The method of claim 7, wherein the special key is one of an asterisk (*) key and a pound (#) key.

10. The method of claim 7, wherein the text message is sent on the callee's phone using at least one of callee's phone number and an Internet Protocol (IP) address of the callee's phone.

11. The method of claim 7, further comprising sending the text message on an e-mail address of the callee.

12. The method of claim 7, further comprising sending the voice message in a digital audio form, on an e-mail address of the callee.

13. A system for sending information from a caller to a callee, the system comprising:
a processor; and
a memory coupled to the processor, wherein the processor executes an algorithm stored in the memory to:
receive a connection request from a caller, wherein the connection request is identified by a special key followed by a callee's phone number;
receive a voice message from the caller;
translate the voice message into a text message; and
send the text message on the callee's phone number.

14. The system of claim 13, wherein the connection request is sent to the server while the callee fails to receive a call from the caller.

15. The system of claim 13, wherein the special key is one of an asterisk (*) key and a pound (#) key.

16. The system of claim 13, further comprising sending the text message on an Internet Protocol (IP) address of the callee's phone.

17. The system of claim 13, further comprising sending the text message on an e-mail address of the callee.

18. The system of claim 13, further comprising sending the voice message in a digital audio form, on an e-mail address of the callee.
